(19) United States
(12) Patent Application Publication
(10) Pub. No.: US 2019/0061044 A1
(43) Pub. Date: Feb. 28, 2019

(54) METHOD FOR MANUFACTURING DOUBLE PIPE

(71) Applicant: HUSCO Co., Ltd, Chungnam (KR)

(72) Inventor: Jin-Hyun JEONG, Incheon (KR)

(73) Assignee: HUSCO Co., Ltd

(21) Appl. No.: 16/171,563

(22) Filed: Oct. 26, 2018

Related U.S. Application Data
(63) Continuation of application No. PCT/KR2017/015652, filed on Dec. 28, 2017.

(30) Foreign Application Priority Data
Jan. 19, 2017 (KR) 10-2017-0009270

(51) Int. Cl. B23K 13/01; B21C 37/08; B21C 37/30; B23K 13/02; B21C 37/15

(52) U.S. Cl. CPC B23K 13/01; B21C 37/0811; B21C 37/08; B23K 2101/10; B23K 13/025; B21C 37/154; B21C 37/30

(57) ABSTRACT

This disclosure relates to a method for manufacturing a double pipe, including: a primary roll forming step of forming bending portions on both sides of a strip for an external pipe in a longitudinal direction; a stacking step of stacking a strip for an internal pipe on the strip for the external pipe; a secondary roll forming step of mechanically coupling the strip for the external pipe and the strip for the internal pipe; a forming step of forming the strip for the external pipe and the strip for the internal pipe, mechanically coupled to each other, into a pipe shape; a welding step of bonding the bending portions on both sides of the strip for the external pipe, and the strip for the internal pipe, which are formed into the pipe shape; and a heat treatment step of heat-treating bonded portions of the strip.

### CROSS REFERENCE TO RELATED APPLICATIONS

This application is a continuation application of PCT Application No. PCT/KR2017/015652, filed on 28 Dec. 2017, which claims the benefit of and priority to Korean Patent Application No. 10-2017-0009270, filed on 19 Jan. 2017. The entire disclosures of the applications identified in this paragraph are incorporated herein by references.

### FIELD

The present disclosure relates to a method for manufacturing a double pipe, and more particularly, to a method for manufacturing a high-performance double pipe by bonding different kinds of materials having different properties.

### BACKGROUND

In general, three methods are known as methods for manufacturing a double wall pipe (also referred to as “double pipe” hereinafter). The double pipe is manufactured in a metallurgical bonding type (which is manufactured by bonding nonferrous metal and steel in a reducing atmosphere of high temperature, and mainly applies to copper or aluminum bonding bearing), in a mechanical bonding type (which is manufactured by inserting two pipes through forced pressing, extrusion, or drawing, and then expanding an inside or pressing an outside, and is mainly applied to a wear resistant double pipe which is worn out), or by forming, inside a steel pipe, an overlay welding type layer made of a high wear resistant and corrosion resistant material. The double pipe is mainly used for piping which requires corrosion resistant or wear resistant inside of a pipe. The double pipe with the enhanced corrosion resistance and wear resistance is widely used as a fluid transfer pipe in a corrosive environment, such as a water pipe in a chlorine atmosphere, a car tailpipe, a heat exchanger, a sand oil transfer pipe, a petrochemical facility, a seawater desalination facility and a fish farm, a plating industry, and a seawater cooling line of a nuclear or thermal power station.

Such a related-art double pipe is disclosed in Korean Patent Registration No. 1483646 (which relates to a clad pipe manufacturing method and a clad pipe manufactured by the manufacturing method, and a bonding method of a clad pipe).

The related-art technology relates to a clad pipe manufacturing method and a clad pipe manufactured by the manufacturing method, and a bonding method of a clad pipe, by which a clad pipe having an inner pipe and an external pipe of different metallic materials coupled to each other by drawing is manufactured, and the manufactured clad pipes are securely bonded to each other. The clad pipe manufacturing method includes: an external pipe preparing step of preparing an external pipe of carbon steel or stainless material; an external pipe coupling recess drawing step of putting the external pipe into a first drawing mold, and forming a plurality of coupling recesses on an inner circumference of the external pipe at equal intervals in a longitudinal direction through drawing; a step of preparing an internal pipe formed of metal of a different material from that of the external pipe to be inserted into the external pipe; and a drawing and manufacturing step of inserting the internal pipe into the external pipe, putting the external pipe and the internal pipe to a second drawing mold, and forming coupling protrusions on the outer circumference of the internal pipe to be inserted into the coupling recesses by pressing the inner circumference of the internal pipe toward the outside to expand through drawing, thereby manufacturing the double pipe.

However, the above-described clad pipe may have gaps between the internal pipe and the external pipe on a bonding portion due to different spring back phenomena, caused by a difference in yield strength and Poisson's ratio when drawing is performed after the external pipe and the internal pipe of different materials are assembled, and water in the atmosphere may permeate the gaps of different materials, and thus bimetallic corrosion or Galvanic corrosion may occur due to a difference in corrosion potential between two materials. In addition, since pipes of different materials are separately manufactured, are pressed, and then are drawn, the cost of different pipe materials and the cost of a drawing process are high, and a material loss is great when the pipe is cut because of length limit in the manufacturing step (typically, 6-9 meters). In addition, the manufacturing process is complicated and thus continuous production is impossible, and the manufacturing cost is high.

### SUMMARY

Therefore, the present disclosure has been developed to solve the problems of the related-art double pipe, that is, occurrence of gaps on the internal pipe and the external pipe caused by spring back due to a difference in elastic modulus and yield strength in plastic working, a length limit of the manufactured pipe according to a condition of the manufacturing process, a working speed in the manufacturing process, price competitiveness, continuous productivity, etc.

An objective of the present disclosure is to provide a method for manufacturing a double pipe, which can prevent gaps, which may occur due to spring back, from occurring in strips of different materials, and can continuously manufacture a double pipe and thus has no limit to the length of the pipe, and can achieve a high working speed, price competitiveness, and continuous productivity.

The objective to be achieved by the present disclosure is not limited to the above-mentioned objective(s), and other objects that have not been mentioned herein will be clearly understood by a person skilled in the art based on the following descriptions.

The present disclosure provides a method for manufacturing a double pipe, the method including: a primary roll forming step of forming bending portions on both sides of a strip for an external pipe in a longitudinal direction; a stacking step of stacking a strip for an internal pipe on the strip for the external pipe; a secondary roll forming step of mechanically coupling the strip for the external pipe and the strip for the internal pipe; a forming step of forming the strip for the external pipe and the strip for the internal pipe, mechanically coupled to each other, into a pipe shape; a welding step of bonding the bending portions on the both sides of the strip for the external pipe, and the strip for the internal pipe, which are formed into the pipe shape; and a heat treatment step of heat-treating bonded portions of the strip for the external pipe and the strip for the internal pipe.

In addition, the present disclosure provides a method for manufacturing a double pipe, the method including: a stacking step of stacking a strip for an internal pipe on a strip for an external pipe; a first welding step of bonding contact surfaces of the strip for the external pipe and the strip for the internal pipe; a forming step of forming the strip for the external pipe and the strip for the internal pipe bonded to each other into a pipe shape; a welding step for bonding both distal ends of the strip for the external pipe and the strip for the internal pipe, formed into the pipe shape, respectively; and a heat treatment step of heat-treating bonded portions of the strip for the external pipe and the strip for the internal pipe.

According to the present disclosure, a high-performance double pipe for a structural purpose and a piping purpose can be implemented by bonding a strip for an internal pipe and a strip for an external pipe of different kinds of materials.

In addition, a high-performance double pipe which can reduce a manufacturing cost and has high strength can be manufactured by using a stainless steel material having good corrosion resistance for an application portion that is easy to corrode, such as a water pipe in a chlorine atmosphere, a transfer pipe in a chemical plant, a street lamp in acid rain, or a structure in the sea, and by bonding a steel material which is cheap and has high strength for a portion that does not corrode.

Furthermore, the method for manufacturing the double pipe according to the present disclosure can continuously manufacture a double pipe, and thus there is no limit to a pipe length, and the internal pipe and the external pipe are securely and tightly coupled to each other, such that durability can be enhanced.

In addition, a structure-purpose double pipe and a piping-purpose double pipe can be manufactured in a simple method by changing materials for the strip for the external pipe and the strip for the internal pipe according to a purpose, or changing a bending direction when the strips are formed into the pipe shape.

### BRIEF DESCRIPTION OF THE DRAWINGS

FIG. 1 is a sequence diagram illustrating a method for manufacturing a double pipe according to the present disclosure;

FIG. 2 is a side view illustrating a process of manufacturing a structure-purpose double pipe according to the present disclosure;

FIG. 3 is a schematic view illustrating a process of manufacturing a structure-purpose double pipe according to the present disclosure;

FIG. 4 is a schematic view illustrating a process of manufacturing a piping-purpose double pipe according to the present disclosure; and

FIG. 5 is a schematic view illustrating a method for manufacturing a piping-purpose double pipe according to another embodiment of the present disclosure.

### DETAILED DESCRIPTION

Hereinafter, preferred embodiments according to the present disclosure will be described in detail with reference to the accompanying drawings.

The advantages and features of the present disclosure, and a method for achieving the same will be clarified by referring to embodiments described below with reference to the accompanying drawings.

The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art. The present disclosure is defined by the claims.

In the description of the exemplary embodiment, certain detailed explanations of related art are omitted when it is deemed that they may unnecessarily obscure the essence of the present disclosure.

The present disclosure provides a method for manufacturing a double pipe, the method including:

a primary roll forming step of forming bending portions on both sides of a strip for an external pipe in a longitudinal direction;

a stacking step of stacking a strip for an internal pipe on the strip for the external pipe;

a secondary roll forming step of mechanically coupling the strip for the external pipe and the strip for the internal pipe;

a forming step of forming the strip for the external pipe and the strip for the internal pipe, mechanically coupled to each other, into a pipe shape;

a welding step of bonding the bending portions on the both sides of the strip for the external pipe, and the strip for the internal pipe, which are formed into the pipe shape; and

a heat treatment step of heat-treating bonded portions of the strip for the external pipe and the strip for the internal pipe.

The method for manufacturing the double pipe according to the present disclosure can implement a high-performance double pipe for a structural purpose and a piping purpose can be implemented by bonding a strip for an internal pipe and a strip for an external pipe of different kinds of materials. Specifically, a high-performance double pipe which can reduce a manufacturing cost and has high strength can be manufactured by using a stainless steel material having good corrosion resistance for an application portion that is easy to corrode, such as a water pipe in a chlorine atmosphere, a transfer pipe in a chemical plant, a street lamp in acid rain, or a structure in the sea, and by bonding a steel material which is cheap and has high strength for a portion that does not corrode. Furthermore, the method for manufacturing the double pipe according to the present disclosure can continuously manufacture a double pipe, and thus there is no limit to a pipe length, and the internal pipe and the external pipe are securely and tightly coupled to each other, such that durability can be enhanced. In addition, a structure-purpose double pipe and a piping-purpose double pipe can be manufactured in a simple method by changing materials for the strip for the external pipe and the strip for the internal pipe according to a purpose, or changing a bending direction when the strips are formed into the pipe shape.

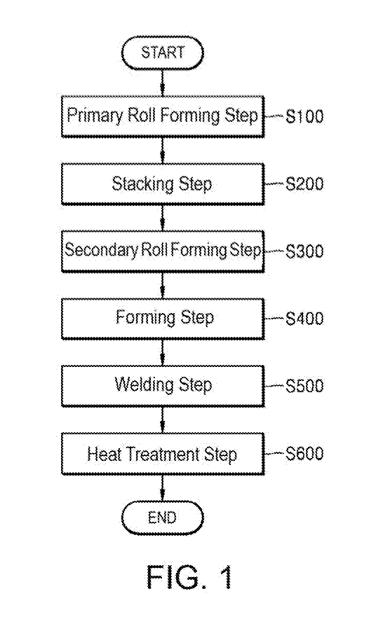

Hereinafter, a method for manufacturing a double pipe according to the present disclosure will be described with reference to FIG. 1.

The method for manufacturing the double pipe according to the present disclosure includes a primary roll forming step (S100) of forming bending portions on both sides of a strip for an external pipe in a longitudinal direction.

In this case, when a structure-purpose double pipe is manufactured, the strip for the external pipe may use a stainless steel material having good corrosion resistance, specifically, ferritic stainless steel or duplex stainless steel, and, when a piping-purpose double pipe is manufactured, the strip for the external pipe may use carbon steel having a tensile strength of 40-70 kgf/mm².

Materials for the strip for the external pipe and the strip for the internal pipe are determined according to the purpose of the double pipe, and specifically, when a structure-purpose double pipe is manufactured, carbon steel is preferably selected for the strip for the internal pipe in consideration of a mechanical characteristic and a relatively low price, and, when a piping-purpose double pipe is manufactured, stainless steel or an aluminum alloy may be used for the strip for the internal pipe.

The strip for the external pipe is put into a primary roll mold and is rolled, and, by doing so, bending portions are formed on both sides of the strip for the external pipe in the longitudinal direction, and the strip for the external pipe has a recess shape) (␣).

The method for manufacturing the double pipe according to the present disclosure includes a stacking step (200) of stacking the strip for the internal pipe on the strip for the external pipe.

The strip for the internal pipe is provided on the recess-shaped strip for the external pipe, and the strip for the internal pipe is stacked on the strip for the external pipe.

The method for manufacturing the double pipe according to the present disclosure includes a secondary roll forming step (S300) for mechanically coupling the strip for the external pipe and the strip for the internal pipe.

The strip for the external pipe and the strip for the internal pipe are put into a secondary roll mold, and the bending portions of the strip for the external pipe, formed by the primary roll forming, bend toward the strip for the internal pipe and mechanically couple thereto through secondary roll forming, such that the two strips of different kinds of materials are integrated.

The method for manufacturing the double pipe according to the present disclosure includes a forming step (S400) of forming the strip for the external pipe and the strip for the internal pipe mechanically coupled to each other into a pipe shape.

The strip for the external pipe and the strip for the internal pipe mechanically coupled to each other may be formed into the pipe shape through a plurality of forming roll molds.

The method for manufacturing the double pipe according to the present disclosure includes a welding step (S500) of bonding the bending portions on both sides of the strip for the external pipe and the strip for the internal pipe, formed into the pipe shape, to each other.

In this case, when the strips are ferritic stainless steel or duplex stainless steel, the strips may be bonded by high-frequency electric welding. The high-frequency electric welding is possible because the stainless steel has magnetism and electrical resistivity is less than or equal to 65 ρΩ·cm. In particular, when the strip for the internal pipe or the strip for the external pipe is carbon steel, electrical resistivity is 16 μΩ·cm during high-frequency heating. Therefore, in the case of the carbon steel, high-frequency heating is easier to do than in the case of stainless steel, and the carbon steel is rapidly heated and melted. Therefore, the stainless steel is made to be heated easily by thermal conduction.

However, austenitic stainless steel does not have magnetic properties and has electrical resistivity of 70 μΩ·cm or higher. Therefore, the austenitic stainless steel is not well heated when high-frequency electric welding is performed, and is difficult to weld. Therefore, the austenitic stainless steel may be welded by one kind of welding selected from the group consisting of laser beam welding, plasma welding, and tungsten inert gas (TIG) welding.

In this case, when the strips are bonded, distal ends of the heated strips may be pressed by a squeeze roller and may be welded.

The method for manufacturing the double pipe according to the present disclosure includes a heat treatment step (S600) of heat-treating bonded portions of the strip for the external pipe and the strip for the internal pipe.

When a pipe is manufactured by welding, component segregation and a welding residual stress of a welding portion caused by welding heat may be solved by heat treatment in a non-oxidation atmosphere, and structure and components may be homogenized. Therefore, good heat-treated structure, corrosion resistance, and good surface of the welding portion can be guaranteed, and thus quality of the double pipe can be enhanced. In addition, the heat treatment is performed at the same time as manufacturing of the pipe, such that the manufacturing cost can be reduced, and a separate pickling process may be omitted and thus an environmental pollution can be prevented.

The heat treatment may be performed in the non-oxidation atmosphere. Specifically, the heat treatment may be performed in an atmosphere of mixture gas of nitrogen or argon gas, which forms an inert atmosphere around the double pipe passing through a heat treatment furnace, and hydrogen which forms a reducing atmosphere, or may be performed in an ammonia gas atmosphere. In this case, in the gas forming the inert atmosphere and the reducing atmosphere, a gas pressure of the gas forming the reducing atmosphere as to the gas forming the inert atmosphere is maintained as about 1 bar, and deformation of the double pipe by an excessive pressure can be prevented, and the pipe can be prevented from being additionally oxidized. In addition, when the double pipe is welded, welding may be performed in the non-oxidation atmosphere in the same way as the heat treatment, a surrounding portion of the welding portion may be blocked and separation of the welding portion caused by oxidization may be prevented. Therefore, high welding strength and uniform welding quality without bubbles on the welding portion can be obtained.

In addition, the heat treatment may be performed at about 1040° C., which is recrystallization temperature of a stainless steel pipe, and internal structure may be solution-heat treated. Accordingly, it is preferable that the heat treatment is performed at 1000 to 1350° C. When the heat treatment is performed at less than 1000° C., there may be a problem in solution heat treatment to homogenize segregated components, and, when the heat treatment is performed at higher than 1350° C., the time required to perform the heat treatment can be reduced, but there may be problems in manufacturing or maintaining a heat treatment facility, and a problem of deformation of the double pipe.

The method for manufacturing the double pipe according to the present disclosure may further include a welding bead removal step of removing welding beads formed in the welding step.

In the method for manufacturing the double pipe according to the present disclosure, welding beads formed on the outside of the double pipe formed in the welding step may be removed by grinding or pressure plastic working, and welding beads formed on the inside of the double pipe may be removed by pressure plastic working or cutting.

In addition, the present disclosure provides a method for manufacturing a double pipe, including:

a stacking step of stacking a strip for an internal pipe on a strip for an external pipe;

a first welding step of bonding contact surfaces of the strip for the external pipe and the strip for the internal pipe;

a forming step of forming the strip for the external pipe and the strip for the internal pipe bonded to each other into a pipe shape;

a second welding step for bonding both distal ends of the strip for the external pipe and the strip for the internal pipe, formed into the pipe shape, respectively; and

a heat treatment step of heat-treating the bonded portion of the strip for the external pipe and the strip for the internal pipe.

The method for manufacturing the double pipe according to the present disclosure may omit the step of forming bending portions on both sides of the strip for the external pipe in the longitudinal direction, and may perform the first welding step of bonding the contact surfaces of the strip for the external pipe and the strip for the internal pipe. In this case, at the first welding step, the contact surfaces of the strip for the external pipe and the strip for the internal pipe may be bonded to each other, and specifically, both distal ends of the strips and a plurality of portions of the contact surfaces may be spot-welded.

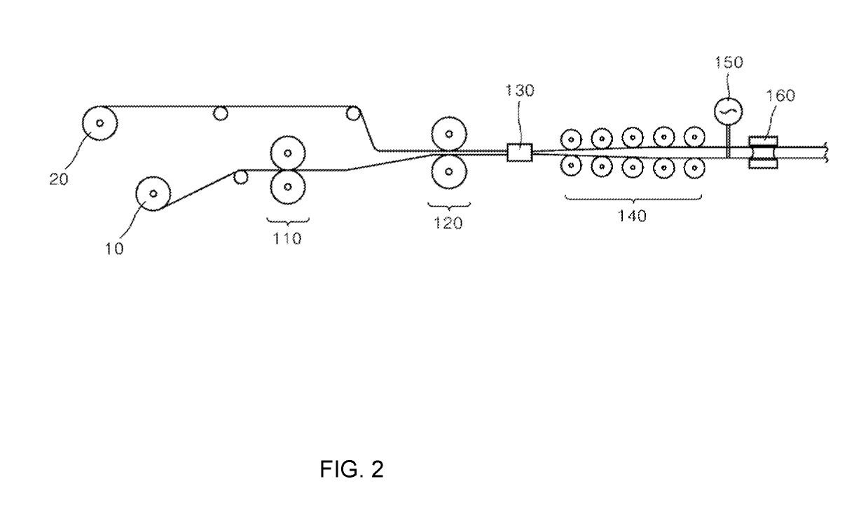

FIG. 2 is a side view illustrating a process of manufacturing a structure-purpose double pipe according to the present disclosure. As shown in FIG. 2, the structure-purpose double pipe according to the present disclosure is manufactured by passing through a primary roll 110, a secondary roll 120, a guide roller 130, a roll former 140, a high frequency generator 150, and a squeeze roller 160.

Specifically, a strip 10 for an external pipe having high corrosion resistance, and a strip 20 for an internal pipe having high strength are supplied, and bending portions are formed on both sides of the strip 10 for the external pipe in the longitudinal direction by the primary roll 110. The strip 20 for the internal pipe is stacked on the strip 10 for the external pipe having the bending portions formed thereon, and the stacked strips are mechanically coupled to each other by the secondary roll 120. The mechanically coupled strips are transferred through the guide roller 130, and enter the plurality of roll formers 140, and are formed to a circular pipe from a plate shape through the plurality of roll formers 140. Distal ends of a tubular body heated by an induced current generated at the high frequency generator 150 are pressed by the squeeze roller 160, such that the strips formed into the circular pipe is electrically welded.

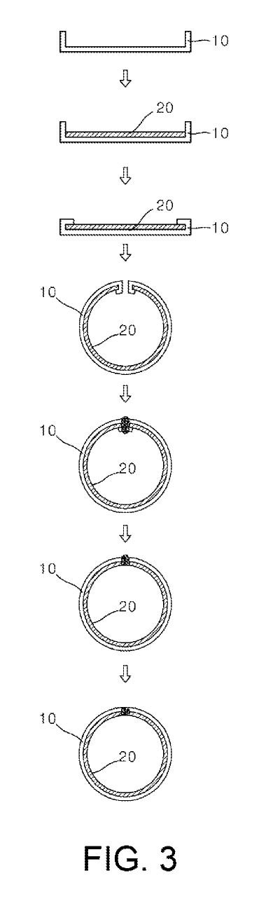

FIG. 3 is a schematic view illustrating a process of manufacturing a structure-purpose double pipe according to the present disclosure. As shown in FIG. 3, primary roll forming is performed with a roll mold to form a recess (U) of a strip 10 for an external pipe made of high-corrosion resistant stainless steel, and a strip 20 for an internal pipe, made of carbon steel which has high strength and is cheaper than the stainless steel, is stacked in the recess. The strip 10 for the external pipe and the strip 20 for the internal pipe may be integrated by being pressed (secondary roll forming) with a roll mold. The strip 10 for the external pipe and the strip 20 for the internal pipe, which are integrated, are formed into a pipe shape through the plurality of roll formers as shown in FIG. 2. Both distal ends of the strip 10 for the external pipe and the strip 20 for the internal pipe, which are formed into the pipe shape, are welded while being pressed by a squeeze roller. Welding beads on a welded outer circumference are removed by grinding or pressure plastic working, and welding beads on a welded inner circumference are removed by rolling-pressing the pressed strips or cutting. The structure-purpose double pipe is manufactured by heat-treating the strips 10, 20 with the welding beads removed.

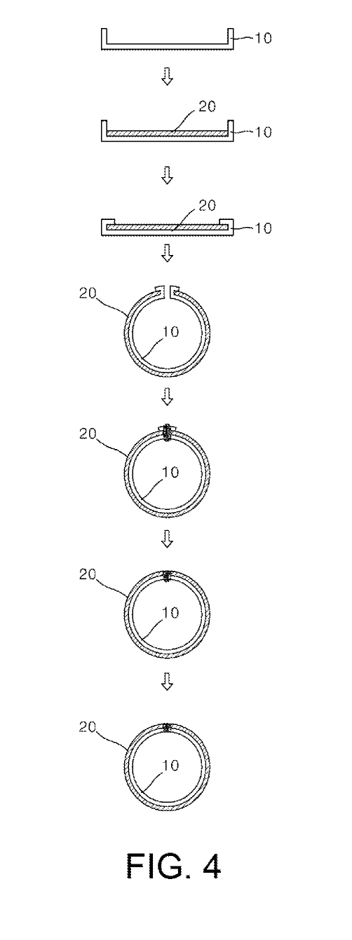

FIG. 4 is a schematic view illustrating a process of manufacturing a piping-purpose double pipe according to the present disclosure. As shown in FIG. 4, for the piping-purpose double pipe, high corrosion resistant stainless steel is used for a strip 10 for an internal pipe, and high strength carbon steel is used for a strip 20 for an external pipe. Therefore, the strips are formed into a pipe shape to have carbon steel form an outer circumference unlike in FIG. 3. The piping-purpose double pipe may be manufactured in the same way as described in FIG. 3, except for that the carbon steel forms the outer circumference.

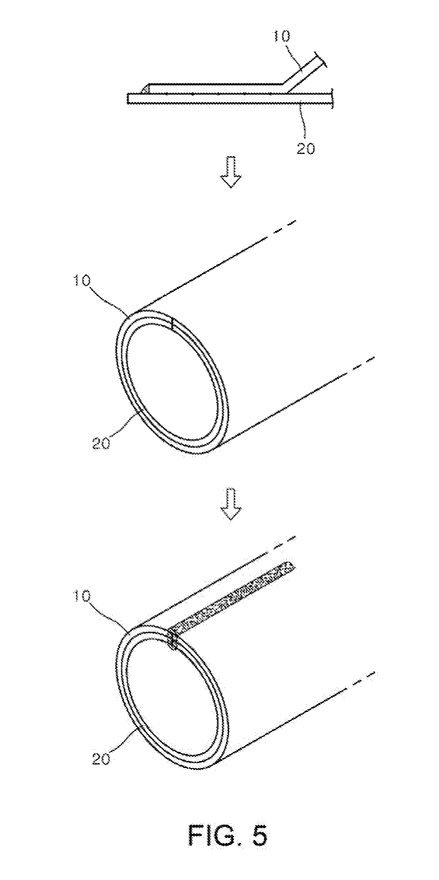

FIG. 5 is a schematic view illustrating a method of manufacturing a piping-purpose double pipe according to another embodiment of the present disclosure. As shown in FIG. 5, for the piping-purpose double pipe, high corrosion resistant stainless steel is used for a strip 20 for an internal pipe, and high strength carbon steel is used for a strip 10 for an external pipe. Both start ends of the respective strips and a plurality of portions of the contact surfaces are spot-welded to prevent the two strips from being moved horizontally and vertically when the strips are stacked. The strips bonded to each other by welding are formed into a pipe shape to have carbon steel form an outer circumference, and both ends of the strips are welded, and finally the piping-purpose double pipe is manufactured. In this case, different welding methods may be performed according to materials of the strip for the internal pipe and the strip for the external pipe as described above.

Up to now, specific embodiments regarding the method for manufacturing the double pipe according to the present disclosure have been described, but it will be obvious that various changes can be made without departing from the scope of the present disclosure.

Therefore, the scope of the present disclosure is not limited by the detailed description of the embodiments, and should be defined by the appended claims and equivalents thereto.

That is, the above-described embodiments are merely examples from all aspects, and should not be considered as limiting, and the scope of the present disclosure should be defined not by the detailed description, but by the appended claims, and the meaning and the scope of the claims and all changes or changed forms derived from the equivalent concept thereof should be interpreted as being included in the scope of the present disclosure.

What is claimed is:

1. A method for manufacturing a double pipe, the method comprising:
a primary roll forming step of forming bending portions on both sides of a strip for an external pipe in a longitudinal direction;
a stacking step of stacking a strip for an internal pipe on the strip for the external pipe;
a secondary roll forming step of mechanically coupling the strip for the external pipe and the strip for the internal pipe;
a forming step of forming the strip for the external pipe and the strip for the internal pipe, mechanically coupled to each other, into a pipe shape;
a welding step of bonding the bending portions on the both sides of the strip for the external pipe, and the strip for the internal pipe, which are formed into the pipe shape; and
a heat treatment step of heat-treating bonded portions of the strip for the external pipe and the strip for the internal pipe.

2. The method of claim 1, further comprising a welding bead removal step of removing welding beads formed at the welding step.

3. The method of claim 1, wherein, when the double pipe is manufactured for a structural purpose, the strip for the external pipe is stainless steel, and the strip for the internal pipe is carbon steel having a tensile strength of 40-70 kgf/mm².

4. The method of claim 1, wherein, when the double pipe is manufactured for a piping purpose, the strip for the external pipe is carbon steel, and the strip for the internal pipe is stainless steel or an aluminum alloy.

5. The method of claim 3, wherein, when the stainless steel is ferritic stainless steel or duplex stainless steel, welding is performed by high-frequency electric welding.

6. The method of claim 3, wherein, when the stainless steel is austenitic stainless steel, welding is performed by one kind of welding selected from the group consisting of laser beam welding, plasma welding, and tungsten inert gas (TIG) welding.

7. The method of claim 4, wherein, when the stainless steel is ferritic stainless steel or duplex stainless steel, welding is performed by high-frequency electric welding.

8. The method of claim 4, wherein, when the stainless steel is austenitic stainless steel, welding is performed by one kind of welding selected from the group consisting of laser beam welding, plasma welding, and tungsten inert gas (TIG) welding.

9. The method of claim 1, wherein the heat treatment is performed in an atmosphere of mixture gas mixed with nitrogen or argon gas and hydrogen, or in an ammonia gas atmosphere.

10. The method of claim 1, wherein the heat treatment is performed at temperature of 1000-1350° C.

11. A method for manufacturing a double pipe, the method comprising:
a stacking step of stacking a strip for an internal pipe on a strip for an external pipe;
a first welding step of bonding contact surfaces of the strip for the external pipe and the strip for the internal pipe;
a forming step of forming the strip for the external pipe and the strip for the internal pipe bonded to each other into a pipe shape;
a welding step for bonding both distal ends of the strip for the external pipe and the strip for the internal pipe, formed into the pipe shape, respectively; and
a heat treatment step of heat-treating bonded portions of the strip for the external pipe and the strip for the internal pipe.
